(19) United States
(12) Patent Application Publication
(10) Pub. No.: US 2015/0221012 A1
(43) Pub. Date: Aug. 6, 2015

(54) METHOD AND SYSTEM FOR FACILITATING THE SALE OF A BUSINESS

(71) Applicants: PATRICK BORODY, COCHRANE (CA); OJAY HEHR, CALGARY (CA); JASON CONLEY, CALGARY (CA)

(72) Inventors: PATRICK BORODY, COCHRANE (CA); OJAY HEHR, CALGARY (CA); JASON CONLEY, CALGARY (CA)

(21) Appl. No.: 14/173,869

(22) Filed: Feb. 6, 2014

(51) Int. Cl. G06Q 30/06; G06Q 30/02

(52) U.S. Cl. CPC G06Q 30/0623; G06Q 30/0241; G06Q 30/0201

(57) ABSTRACT

A method and system of facilitating the sale of a business is disclosed herein. The method includes the step of receiving first data from a seller with a server wherein the first data corresponds to a business being offered for sale. The method also includes the step of controlling at least a portion of a display screen with the server wherein at least a portion of the first data is displayed. The method also includes the step of receiving second data from a buyer with the server wherein the second data corresponds to qualifications of the buyer. The method also includes the step of transmitting the second data with the server to the seller after the step of receiving the second data.

### BACKGROUND OF THE INVENTION

1. Field of the Invention

The present invention generally relates to electronic commerce and information management, and more specifically, to a system and method for facilitating the buying and selling of businesses.

2. Description of Related Prior Art

U.S. Pat. No. 6,871,140 discloses SYSTEM AND METHOD FOR COLLECTION, DISTRIBUTION, AND USE OF INFORMATION IN CONNECTION WITH COMMERCIAL REAL ESTATE. The system and method is for creating a unified commercial real estate data model through collection, distribution and use of information in connection with commercial real estate and for creating a web-based marketplace that facilitates the efficient and secure buying and selling of commercial properties. The invention of the '140 patent provides a digital marketplace in which the members of the commercial real estate and related business community can continuously interact and facilitate transactions by efficiently exchanging accurate and standardized information. The present invention also facilitates mortgage lending and provides enough information to allow lenders to underwrite a property. The present invention also provides a mobile data gathering and dissemination vehicle as well as a system tracking and dispatch of mobile vehicles. The present invention further provides correlation of data stored in a remote location to vehicle position in real time.

### SUMMARY OF THE INVENTION

In summary, the invention is a method and system of facilitating the sale of a business. The method includes the step of receiving first data from a seller with a server wherein the first data corresponds to a business being offered for sale. The method also includes the step of controlling at least a portion of a display screen with the server wherein at least a portion of the first data is displayed. The method also includes the step of receiving second data from a buyer with the server wherein the second data corresponds to qualifications of the buyer. The method also includes the step of transmitting the second data with the server to the seller after the step of receiving the second data.

### BRIEF DESCRIPTION OF THE DRAWINGS

The detailed description set forth below references the following drawings:

FIG. 1 is a first screen shot of a display being controlled by a system according to an exemplary embodiment of the invention;

FIG. 2 is a second screen shot of a display being controlled by the system according to an exemplary embodiment of the invention;

FIG. 3 is a schematic illustration of the system according to an exemplary embodiment of the invention; and

FIG. 4 is simplified flow diagram of a method executed by the system according to an exemplary embodiment of the invention.

### DETAILED DESCRIPTION OF AN EXEMPLARY EMBODIMENT

The invention, as demonstrated by the exemplary embodiment described below, can provide a platform for transferring a business between parties. Numerous businesses are valued between $20,000 and $100,000. Commercial agents or realtors often charge a retainer or commission based on fixed fee or percentage of the selling price. Often, the retainer/commission makes selling a business through a commercial agent or realtor not feasible. An embodiment of the present disclosure can allow a business owner to more efficiently locate a buyer of the business. Commercial realtors can still be used, albeit under a narrower, less expensive scope, such as strictly for providing counsel on the sales contract. An embodiment of the present disclosure can be a website that displays businesses that are available for sale. The listings that are displayed can be controlled through filtering and advertising can be offered for sale to third parties. The listings can be user-managed.

An embodiment of the present disclosure can also allow a business owner to screen potential buyers. For example, an embodiment of the present disclosure can receive data from a potential buyer and communicate this data to the seller. The data can be communicated “blindly” so that the potential buyer cannot communicate directly with the seller until the seller desires such communication.

An embodiment of the present disclosure can also allow service professionals to advertise to buyers and sellers of businesses. For example, available businesses can be displayed on a website. Advertisements that operate as hyperlinks can be displayed with the business listings. A buyer or seller can click an advertisement and be directed to another webpage containing more information about one or more particular service professionals.

In an embodiment of the present disclosure, a seller can upload and thus transmit “first data” to a server. The first data can be transmitted to the server with electronic computing devices being operated by sellers. An electronic computing device operated by a seller can be a laptop computer, a desktop computer, a smart-phone, a tablet, an e-reader, or any other electronic computing device operable to receive and transmit textual, video and/or audio data associated with a business.

The first data corresponds to a business being offered for sale. The first data can include the location of the business, the category of the business, and a price requested by the seller. The first data can also include other attributes of the business, such as years of operation, recent improvements, community involvement, and any other data that might be of interest to a potential buyer. The first data can be used by the server to establish a listing for the seller's business. The listing can thus be user-managed. The seller can be charged a fee for the listing. The display of the listing can be delayed until the fee is collected. The fee can be collected by the server, such as by credit card payment.

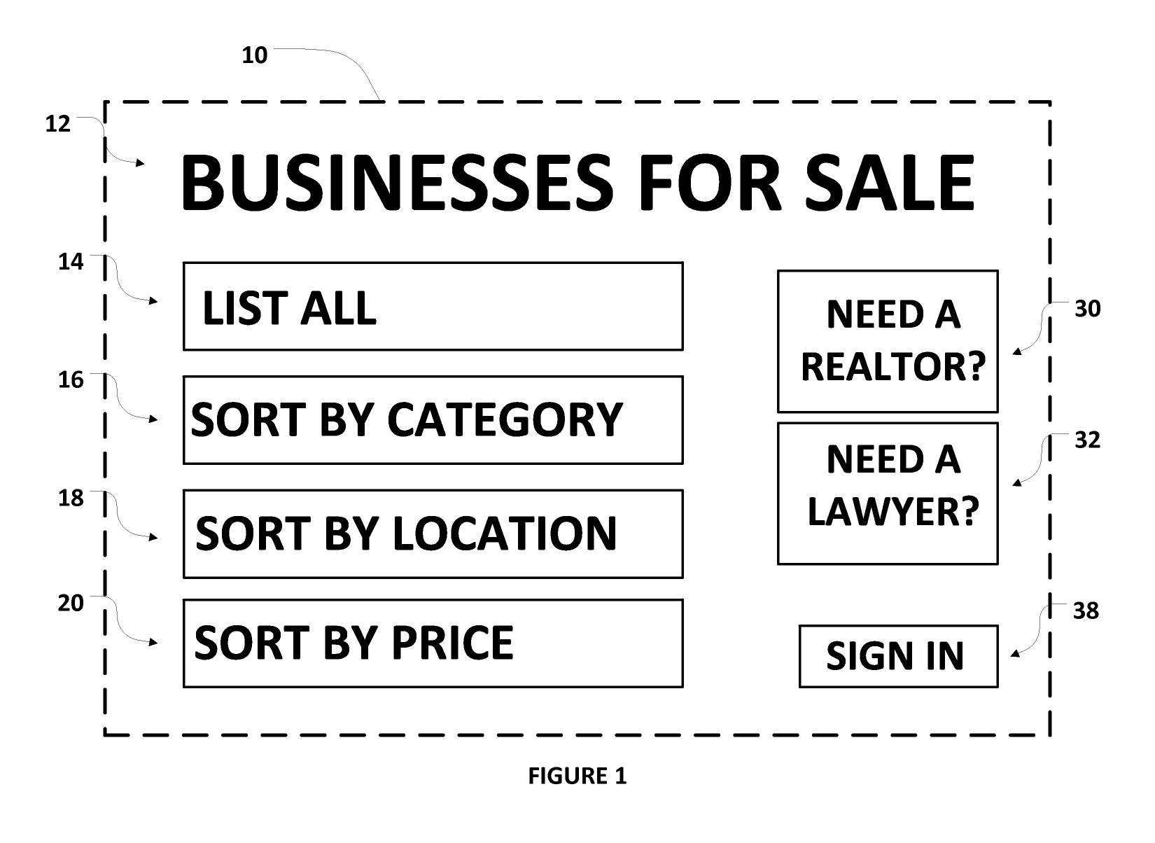

FIG. 1 is a first screen shot of a display being controlled by a system according to an exemplary embodiment of the present disclosure. In FIG. 1, a display screen 10 is controlled by a server operating an embodiment of the present disclosure. The indicia visible on the screen 10 includes a title portion 12 indicating functionality and a plurality of selectable buttons. A button 14 allows a potential buyer to view all business listings maintained by the server. A button 16 allows the potential buyer to selectively view business listings by filtering the listings according to a category. Categories can include restaurants, service businesses, and retails stores, by way of example and not limitation. It is noted that embodiments of the invention may permit a buyer further options, such as nested filtering by category and further sub-categories. For example, a buyer could be allowed to search for restaurants generally and Italian restaurants in particular. A button 18 allows the potential buyer to selectively view business listings by filtering the listings according to location. A button 20 allows the potential buyer to selectively view business listings by filtering the listings according to price. Nested filtering can also be provided based on location and price. It is noted that one or more embodiments of the invention can permit potential buyers free access to the listings of available businesses.

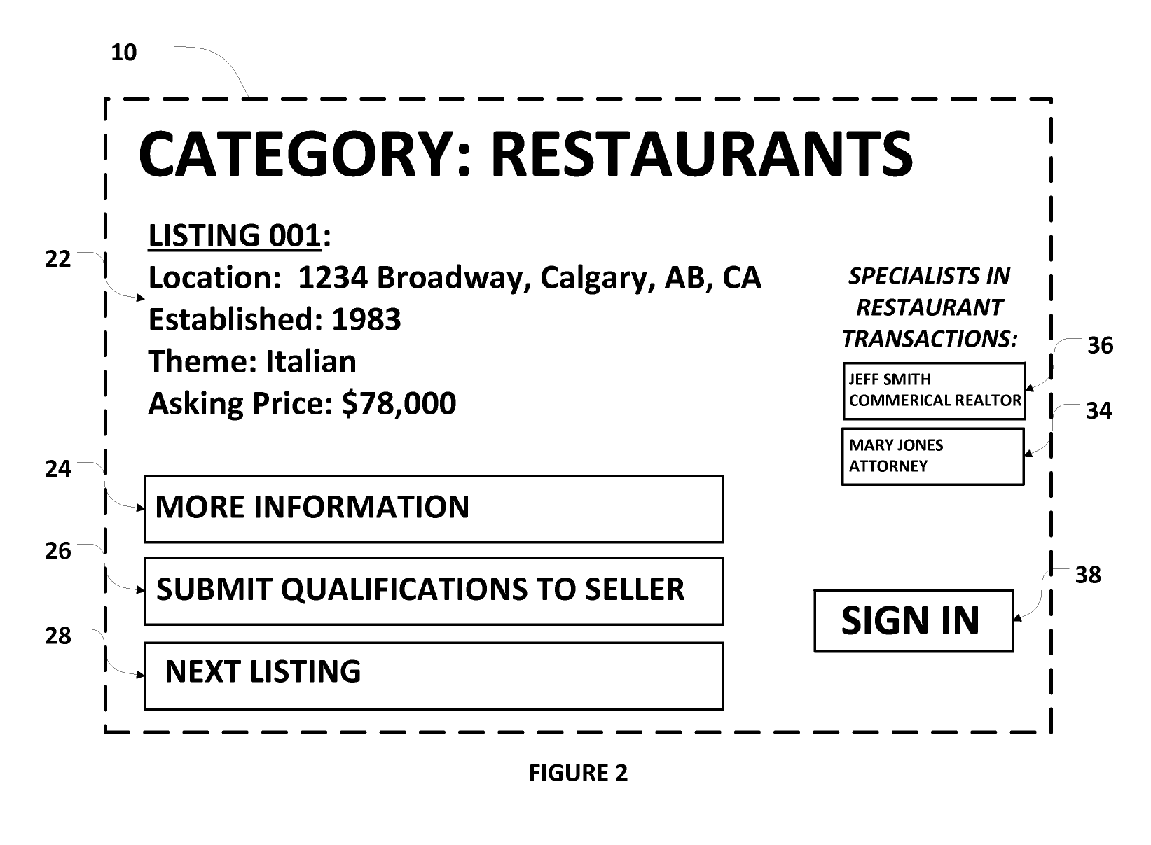

FIG. 2 is a second screen shot of a display being controlled by the system according to an exemplary embodiment of the invention. In FIG. 2, an exemplary search result is being displayed. A business listing is the exemplary search result and is displayed on the screen 10. First data is displayed on the screen 10 and is referenced at 22. A button 24 allows a potential buyer to obtain more information about the particular business if desired. If the buyer is interested in purchasing the business, a button 26 allows a potential buyer to upload additional information. This information can be referred to as “second data” and can be in various formats. Second data can be in the form of electronic files, such as pdfs, word documents, spreadsheets, audio files, video files, html, or any other format. The second data can generally be indicative of the buyer's capacity to purchase the business. The seller can assess the legitimacy of the buyer based on the second data. In some cases, the second data may indicate that the buyer is not credible and the seller can thus avoid wasting resources engaging the buyer. If the buyer is not interested in purchasing the business, a button 28 allows a potential buyer to view another listing.

The second data can be transmitted to the seller in various ways in embodiments of the present disclosure. The second data can be directed to the seller by electronic mail or fax. Alternatively, the second data can be directed to the seller by text message or partially by text message.

FIGS. 1 and 2 also show another aspect of the exemplary embodiment of the present disclosure. An embodiment of the present disclosure can maintain a database of advertisements accessible by the server. The server can retrieve the advertisements and display advertisements on the screen of the buyer's electronic computing device. Stored advertisements can be organized into a plurality of different categories, including different professional services categories. For example, FIG. 1 includes buttons 30 and 32. The button 30 can be selected by a buyer or seller. In response, the server can display a listing of realtors available to assist the buyer. In response to the selection of button 32, the server can display a listing of attorneys.

At least some of the advertising entries stored in the database can be correlated with a particular geographic range, a particular business category, and a business price range. The server can thus select a particular advertisement in response to filtering chosen by the user. For example, FIG. 2 shows a listing for a restaurant. The listing was chosen and is displayed based on the filtering chosen by a potential buyer. The server has selected two advertisements in response to the first data 22. The server has selected a first advertisement 34 for an attorney and a second advertisement 36 for a realtor. The server has examined data associated with all of the possible advertisements and determined that the advertisements 34 and 36 are particularly relevant to the buyer based on the buyer's interest in restaurants.

Each advertisement 34, 36 can function as button. When selected, either advertisement/button 34, 36 can cause the server to display a webpage with more information about the subject of the advertisement.

FIGS. 1 and 2 also show another aspect of the exemplary embodiment of the present disclosure. The server can establish and maintain accounts for frequent users. A “sign in” button is referenced at 38 in FIGS. 1 and 2. A server according to an embodiment of the present disclosure can allow a frequent user to store particular search filtering approaches and/or listings of interest.

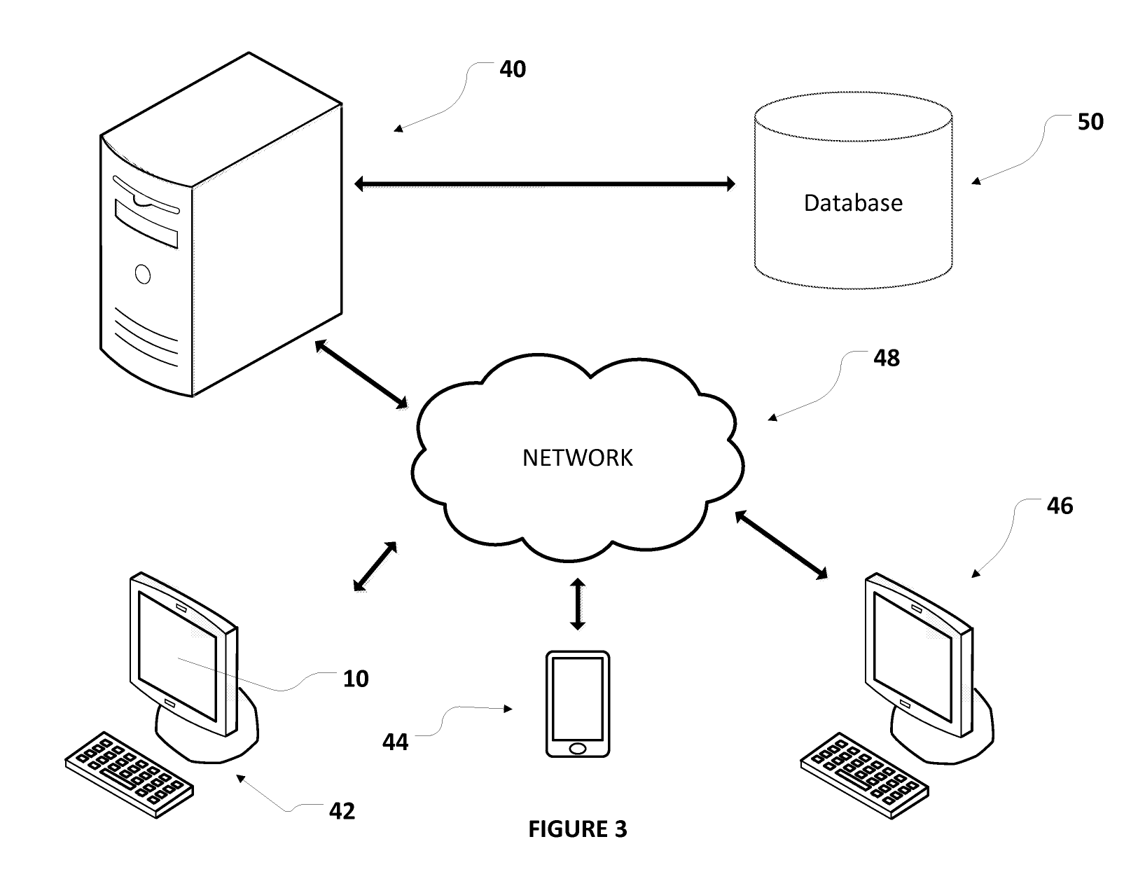

FIG. 3 is a schematic illustration of the system according to an exemplary embodiment of the invention. FIG. 3 shows a server 40 operable to receive first data from a seller. A seller can be communicating with the server 40 from an electronic computing device 42. FIG. 3 also shows that the server 40 can communicate with multiple electronic computing devices 42, 44, 46 and electronic computing devices 42, 44, 46 of different configurations.

The seller can be communicating with the server 40 over a network 48. As used herein, the term “network” can include, but is not limited to, a Local Area Network (LAN), a Metropolitan Area Network (MAN), a Wide Area Network (WAN), the Internet, or combinations thereof. Embodiments of the present disclosure can be practiced with a wireless network, a hard-wired network, or any combination thereof.

The system shown in FIG. 3, an embodiment of the present disclosure, also includes a database 50 of advertisements accessible by the server 40. The database 50 can also be used to store user data, such as user accounts and usage patterns. The server 40 and the database 50 can be integral or can be remote from one another and communicate over the network 48.

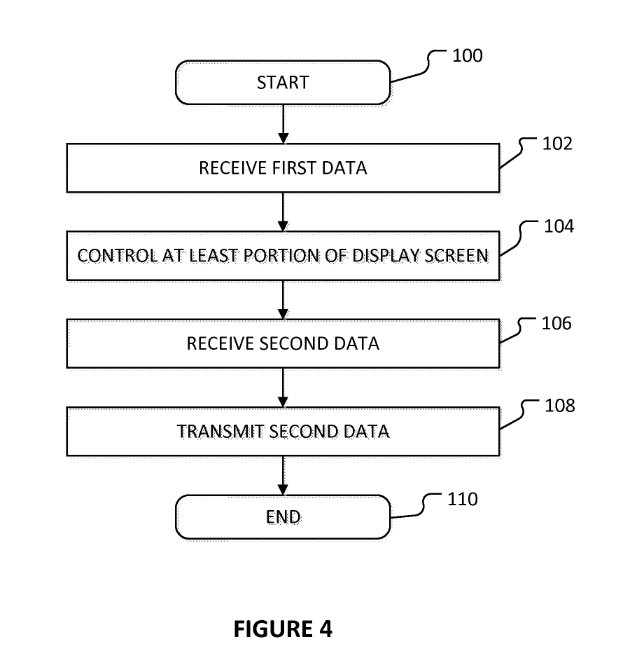

FIG. 4 is simplified flow diagram of a method executed by the system according to an exemplary embodiment of the invention. FIG. 4 is a flow chart illustrating a method that can be carried out in some embodiments of the present disclosure. The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

FIG. 4 is a flow chart illustrating a method that can be carried out in some embodiments of the present disclosure. The method can be executed by a server. The method starts at step 100. At step 102, the server can receive first data from a seller. The first data corresponds to a business being offered for sale. The data can include, by way of example and not limitation, data indicating the nature or category of the business, the location of the business, and the price desired for purchase of the business. The first data can received over a network from a computing device.

At step 104, the server can control at least a portion of a display screen. The display screen can be the screen of a computing device being used by a potential buyer of a business. The first data received from the seller is displayed. The control can be exerted in response to an inquiry made by the potential buyer. The buyer can initiate the inquiry on the computing device. The inquiry can be transmitted to the server from the computing device over the network.

At step 106, the server can receive second data from the buyer. The second data corresponds to qualifications of the buyer. If the buyer is interested in purchasing a business, the buyer can transmit the second data to the server. The second data can be transmitted to the server from the computing device being used by the buyer over the network. The second data can be in the form of electronic files, such as pdfs, word documents, spreadsheets, audio files, video files, html, or any other format.

At step 108, the server can transmit the second data to the seller. The seller can then consider the qualifications of the buyer before expending resources to engage in purchasing negotiations with the buyer. The exemplary process ends at step 110.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Further, the “invention” as that term is used in this document is what is claimed in the claims of this document. The right to claim elements and/or sub-combinations that are disclosed herein as other inventions in other patent documents is hereby unconditionally reserved.

What is claimed is:

1. A method of facilitating the sale of a business comprising:
receiving first data from a seller with a server wherein the first data corresponds to a business being offered for sale;
controlling at least a portion of a display screen with the server wherein at least a portion of the first data is displayed;
receiving second data from a buyer with the server wherein the second data corresponds to qualifications of the buyer; and
transmitting the second data with the server to the seller after said step of receiving the second data.

2. The method of claim 1 wherein said step of receiving first data is further defined as:
receiving first data from a seller with the server wherein the first data includes the location of the business, the category of the business, and a price requested by the seller.

3. The method of claim 1 further comprising the step of:
collecting a fee with the server before executing said controlling step.

4. The method of claim 1 further comprising:
maintaining a database of advertisements accessible by the server.

5. The method of claim 4 wherein said maintaining step includes the step of:
storing advertisements in a plurality of different categories at least including different professional services categories.

6. The method of claim 5 wherein said storing step is further defined as:
storing advertisements in a plurality of different categories at least including professional services categories of attorneys and realtors.

7. The method of claim 6 wherein said maintaining step includes the step of:
correlating at least some of the advertisements with a particular geographic range, a particular business category, and a business price range.

8. The method of claim 7 further comprising:
selecting one or more of the advertisements from the database by the server; and
wherein said controlling step is further defined as controlling at least a portion of the display screen with the server wherein at least a portion of the first data is displayed and the one or more advertisements are displayed.

9. The method of claim 8 wherein said selecting step includes:
selecting, with the server, the one or more advertisements from the database in response to the first data.

10. The method of claim 9 wherein said selecting step includes:
selecting a first advertisement of an attorney; and
selecting a second advertisement of a realtor.

11. The method of claim 10 wherein said controlling step is further defined as:
controlling at least a portion of the display screen with the server wherein at least a portion of the first data is displayed and the first advertisement and second advertisement are displayed.

12. The method of claim 11 wherein said step of receiving second data is further defined as:
receiving second data from the buyer with the server wherein the second data is contained in an electronic file uploaded by the server.

13. The method of claim 12 wherein said transmitting step is further defined as:
directing the electronic file to the seller.

14. The method of claim 13 wherein the directing step is further defined as:
directing the electronic file to the seller by electronic mail or fax.

15. The method of claim 13 wherein the directing step is further defined as:
directing the electronic file to the seller by text.

16. A system for facilitating the sale of a business comprising:
a server operable to receive first data from a seller wherein the first data corresponds to a business being offered for sale, operable to control at least a portion of a display screen wherein at least a portion of the first data is displayed, operable to receive second data from a buyer wherein the second data corresponds to qualifications of the buyer, and operable to transmit the second data to the seller.

17. The system of claim 16 further comprising:
a database of advertisements accessible by the server.

18. The system of claim 17 wherein said server and said database are integral.

19. The system of claim 17 wherein said server and said database are remote from one another.

20. The system of claim 19 wherein said server and said database communicate with one another over a network.
